(19) United States
(12) Patent Application Publication
(10) Pub. No.: US 2008/0095940 A1
(43) Pub. Date: Apr. 24, 2008

(54) Method and Apparatus for Non-Contact Type Direct Dye-Sublimation Printing

(75) Inventors: Sang-Gi Lee, Daegu (KR); Kyung-Won Min, Seoul (KR)

Correspondence Address: THE WEBB LAW FIRM, P.C., 700 KOPPERS BUILDING, 436 SEVENTH AVENUE, PITTSBURGH, PA, 15219, US

(73) Assignees: Kostech Inc., Seocho-ku, Seoul (KR); T.P.M. Co., Ltd., Dalseo-gu, Daegu (KR)

(21) Appl. No.: 11/587,683

(22) PCT Filed: Apr. 28, 2005
(86) PCT No.: PCT/KR05/01226

§ 371 Date: Jul. 17, 2007

(30) Foreign Application Priority Data
Apr. 28, 2004 (KR) 10-2004-0029495

(51) Int. Cl. D06P 5/26; B05D 1/36; B41F 7/02

(52) U.S. Cl. 427/258; 101/488; 101/217

(57) ABSTRACT

An apparatus and method of printing patterns, an ornamental design or a picture on a printing object using a heat transfer or sublimation transfer technology are provided. In the non-contact type direct dye-sublimation printing method, and agent treatment layer is formed in a printing object, and solid sublimation dye is carried in the agent treatment layer by spraying liquid sublimation dye on the agent treatment layer to allow a transfer image to be infiltrated into the agent treatment layer and hardening the liquid sublimation dye infiltrated into the agent treatment layer. The transfer image is printed on the printing object by sublimating the dye carried on the agent treatment layer and infiltrating the sublimated dye into enlarged pores of a texture of the printing object by heating the printing object. The non-contact type direct dye-sublimation printing apparatus can be manufactured in a simple structure and a small size by omitting a pressing plate, a thermostat and other relating parts that are required in a process for depressing an intermediate transfer medium, thereby reducing the facility costs and the initial investing costs and to provide a printing method using such a printing apparatus.

### TECHNICAL FIELD

The present invention relates to an apparatus of printing patterns, an ornamental design or a picture on a printing object using a heat transfer or sublimation transfer technology, and more particularly, to a non-contact type direct dye-sublimation printing apparatus that can remarkably improve the printing quality and efficiency without using an intermediate transfer medium (a transfer paper) and without performing a process of depressing the intermediate transfer medium onto a printing object and can be inexpensively manufactured by being designed in a small, simple structure, thereby lowering initial investing costs. The present invention further relates to a non-contact type direct dye-sublimation printing method.

### BACKGROUND ART

As a conventional printing method using a heat transfer or sublimation transfer technology, two typical methods, a press roller method (refer to FIG. 1) and a plate-type transfer method (refer to FIG. 2) are well known. The press roller method is designed to print an image such as a picture, an ornament design and patterns on a printing object 100 such as a polyester fabric by transferring the image carried on a surface of an intermediate transfer medium 110 to the printing object using a pair of heat/press rollers 120.

In order to carry the image on the surface of the intermediate transfer medium 110, a coating layer 112 is formed on the surface of the intermediate transfer medium and sublimation dye formed of transfer ink is sprayed on the coating layer 112 to form a transfer image. The transfer image formed of the sublimation dye is existed in a solid state at a normal temperature and sublimated when the intermediate medium with the transfer image passes through the heat/press rollers 120 to be transferred from the intermediate medium to the printing object, thereby printing the image such as the picture, the ornament design or a variety of patterns on the printing object.

Meanwhile, FIG. 2 shows another printing method using the plate-type transfer method. The plate-type transfer is designed to print an image on a printing object by disposing the printing object on a lower base 205, disposing an intermediate medium 220 provided at a front surface with a transfer image 222 formed of dye on the printing object, and depressing a rear surface of the intermediate transfer medium 220 at a temperature of about 180-230° C. using a heat-press plate 230 to transfer the transfer image to the printing object 210.

In the above-described conventional printing methods, excessive thermal stress may be incurred on the printing object, causing the defective printing. Korean Laid-Open Patent No. 2003-00929885 discloses a printing method that can prevent the excessive thermal stress. That is, in order to prevent the excessive thermal deviation from being generated during the heating and depressing of the printing object, there are provided upper and lower heating plates to realize the image transfer by starting heating the printing object from a lower portion of the printing object.

However, as shown in FIG. 3, all of the above-described conventional arts, however, are designed to be essentially in need of an identical or similar process. That is, all of the above-described conventional arts are essentially in need of an intermediate transfer medium 310 on a surface of which a transfer image dye 312 that is to be transferred to a printing object 300 is carried. Therefore, a process for depressing the intermediate transfer medium 310 toward the printing object 300 is essentially required to transfer the image from the intermediate transfer medium 310 to the printing object 300.

That is, the transfer image dye (transfer ink) is carried in a coating layer 320 of the intermediate medium. The transfer image dye is existed in a solid state at a normal temperature and sublimated when it is heated at a temperature of 180-230° C. for 0.5-5 minutes. In the course of sublimation, as indicated by Allow in FIG. 3, the transfer image dye 312 sublimated is infiltrated enlarged pores of an texture of the printing object 300 such as the polyester fabric, thereby printing the image on the printing object 300.

When the printing object 300 in which the transfer image dye 312 is infiltrated is cooled at the normal temperature, the pores of the texture of the printing object is contracted to prevent the infiltrated dye from discharged out of the pores, thereby fixing the printed state. According to the above-described prior arts, as the intermediate transfer medium is essentially required, the heating and pressing processes must be essentially performed.

However, since the pressing process must be performed for a predetermined time in a state where the intermediate transfer medium 310 is in contact with the printing object 300 at a predetermined location and a predetermined gap between them, the printing machine is complicated and it is difficult to setup the online printing process in an automation aspect. Therefore, the printing efficiency is lowered and there is limitation in improving the productivity unless a large-sized printing machine is not provided.

Furthermore, after the image is transferred from the intermediate transfer medium 310 to the printing object 300, the intermediate transfer medium is dumped in a state there is still a large amount of residual dye in the coating layer 312 of the intermediate transfer medium 310. This may cause the excessive and unnecessary dye loss.

Furthermore, as shown in FIG. 3, in the course of the infiltration of the dye 312 into the pores of the printing object 300 by the sublimation of the dye by the heating/pressing process, the dye may be infiltrated in the intermediate transfer medium 310 as well as in the printing object 300, thereby deteriorating the printing quality of the printing object 300.

In the constitution aspect of the prior arts, an additional heating/pressing plate 330 for depressing the intermediate transfer medium 310 to the printing object 300 is required. Therefore, when a size of the printing object is relatively large, the size of the heating/pressing plate 330 must be enlarged in response to the size of the heating/pressing plate. This causes the increase of the size of the printing machine.

That is, the prior printing machine must be structured in a large-size, thereby increasing the facility costs.

Furthermore, since the transfer of the dye from the intermediate transfer medium 310 to the printing object 300 must be uniformly realized, a gap and a location between the intermediate transfer medium 310 and the printing object 300 must be uniformly maintained to minimize a local printing quality deviation on the printing object 300. Therefore, further additional units such as a gap maintaining unit and a thermo-hydrostat must be equipped. This causes the further increase of the manufacturing cost of the printing machine.

Meanwhile, Korean Patent No. 0340241 discloses a technology for printing waterproof inkjet ink on a fabric, which can be used for an outdoor advertisement, without using the intermediate transfer medium and the pressing process. According to this technology, there is no need of performing an additional waterproof coating process. However, a thick coating layer must be coated on the fabric to receive the inkjet ink, quality and ventilation of the fabric is deteriorated. Furthermore, it cannot be expected to obtain the printing effect at a rear surface of the printed fabric. In addition, delaminating may be incurred on the printed fabric and the printed image may be deleted by rainwater or the like, thereby deteriorating the quality of the goods with the printed fabric. Furthermore, the production method using this technology increases the defective rate of the goods. In addition, since a mixture of silica, binder and surface-active agent is applied to the fabric, the delaminating may be easily incurred. As a result, stains may be formed on the printed fabric, thereby deteriorating the value of the printed fabric.

### DISCLOSURE OF INVENTION

### Technical Problem

One object of the present invention is to provide a non-contact type direct dye-sublimation printing apparatus that can be inexpensively manufactured by omitting an intermediate transfer medium and to provide a printing method using such a printing apparatus.

Another object of the present invention is to provide a non-contact type direct dye-sublimation printing apparatus and method that can improve the productivity in printing work by omitting a process for depressing an intermediate transfer medium to a printing object, which has been a particular process in the prior art, and by allowing for a consecutive online printing work for the printing object.

A further another object of the present invention is to provide a non-contact type direct dye-sublimation printing apparatus that can be manufactured in a simple structure and a small size by omitting a pressing plate and other relating parts that are required in a process for depressing an intermediate transfer medium, thereby reducing the facility costs and the initial investing costs and to provide a printing method using such a printing apparatus.

A still further another object of the present invention is to provide a non-contact type direct dye-sublimation printing apparatus and method that can provide a superior printing effect using a small amount of the dye by preventing unnecessary dye loss that is caused by an intermediate transfer medium and improve the color fixing property, thereby improving the printing quality.

### Technical Solution

In order to achieve the above objects, the present invention provides a non-contact type direct dye-sublimation printing method comprising the steps of forming an agent treatment layer in a printing object; carrying solid sublimation dye in the agent treatment layer by spraying liquid sublimation dye on the agent treatment layer to allow a transfer image to be infiltrated into the agent treatment layer and hardening the liquid sublimation dye infiltrated into the agent treatment layer; and printing the transfer image on the printing object by sublimating the dye carried on the agent treatment layer and infiltrating the sublimated dye into enlarged pores of a texture of the printing object by heating the printing object.

According to another aspect of the present invention, there is provided a non-contact type direct dye-sublimation printing apparatus comprising a printing object supply unit having a supply reel around which a printing object with an agent treatment layer is rolled and a pair of pinch rolls releasing the printing object from the supply reel; a dye depositing unit disposed at a downstream side of the supply unit to allow dye to be carried in the agent treatment layer; and a transfer unit disposed at a downstream side of the dye depositing unit to print a transfer image on the printing object by sublimating the dye carried in the agent treatment layer and infiltrating the sublimated dye into enlarged pores of a texture of the printing object by heating the printing object.

### ADVANTAGEOUS EFFECTS

According to a non-contact type direct dye-sublimation printing method of the present invention, no process for depressing an intermediate transfer medium such as a transfer paper to a printing object such a polyester fabric or the like to print patterns, an ornamental design or a picture on the printing object by using a heat transfer or sublimation transfer technology is necessary. Accordingly, the apparatus can be manufactured in a simple and small structure and the working process can be simplified. As a result, the facility costs and the initial investing costs can be lowered. In addition, it is possible to consecutively perform the online printing work for the printing object, thereby remarkably improving the productivity in the printing work.

Furthermore, since the present invention is not in need of an intermediate transfer medium such as an expensive transfer paper, the printing costs can be saved. In addition, since the dye is fully transferred to a printing object without remaining on the intermediate transfer medium, unnecessary dye loss can be prevented. As a result, the high quality printing effect can be obtained even using a small amount of dye, thereby saving the printing costs.

In addition, since the pores of the printing object are fully filled with dye, more clear, high resolution printed image can be maintained on the dyed printing object.

Furthermore, since the printing operation for a printing object is performed by a small transferring unit that is detachably arranged in front of a dye depositing unit, the printing apparatus can be minimized and the facility and investing costs can be saved.

### BRIEF DESCRIPTION OF THE DRAWINGS

FIG. 1 is a side sectional view illustrating a conventional heating/pressing roller type indirect transfer printing method and apparatus;

FIG. 2 is a side sectional view illustrating a conventional heating/pressing plate type indirect transfer printing method and apparatus;

FIG. 3 is a view illustrating a basic principle of a conventional plate-type heating/pressing indirect transfer printing method and apparatus;

FIG. 4 is a view illustrating a non-contact type direct dye-sublimation printing method by steps according to an embodiment of the present invention;

FIG. 5 is a side view of a non-contact type direct dye-sublimation printing apparatus according to an embodiment of the present invention;

FIG. 6 is a side view of a non-contact type direct dye-sublimation printing apparatus according to another embodiment of the present invention;

FIG. 7 is a photograph of a texture of a fabric that is being dyed by a non-contact type direct dye-sublimation printing method according to the present invention;

FIG. 8 is a photograph of a texture of a fabric that is being dyed by a non-contact type direct dye-sublimation printing method according to the present invention, in which an agent treatment layer is formed on the fabric; and

FIG. 9 is a photograph of a texture of a fabric that is being dyed by a non-contact type direct dye-sublimation printing method according to the present invention, in which dye is transferred to a fabric to completely dye the texture.

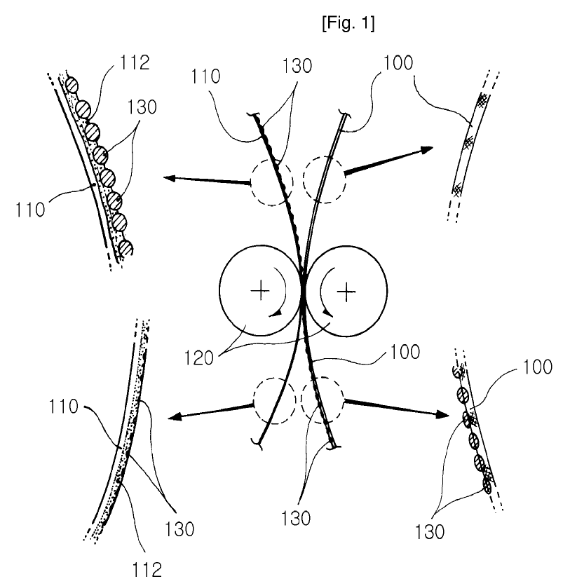

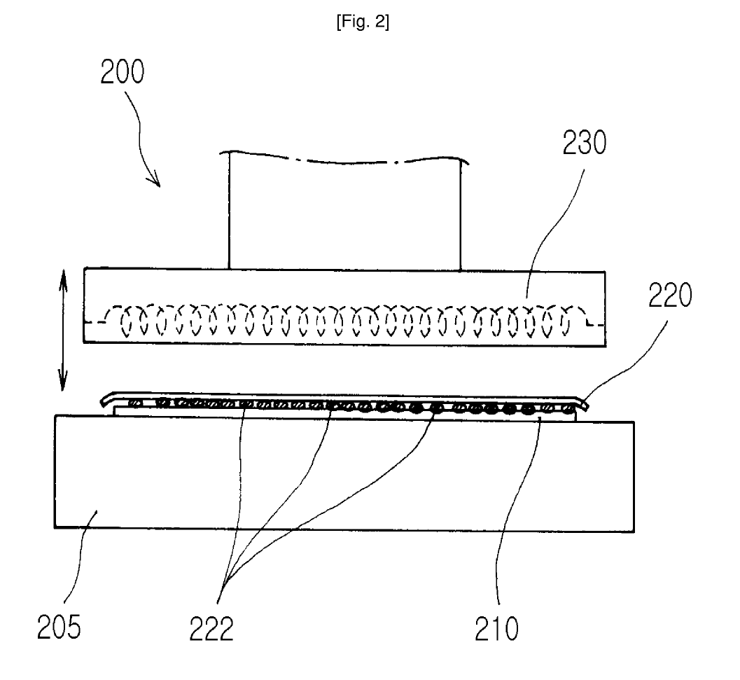

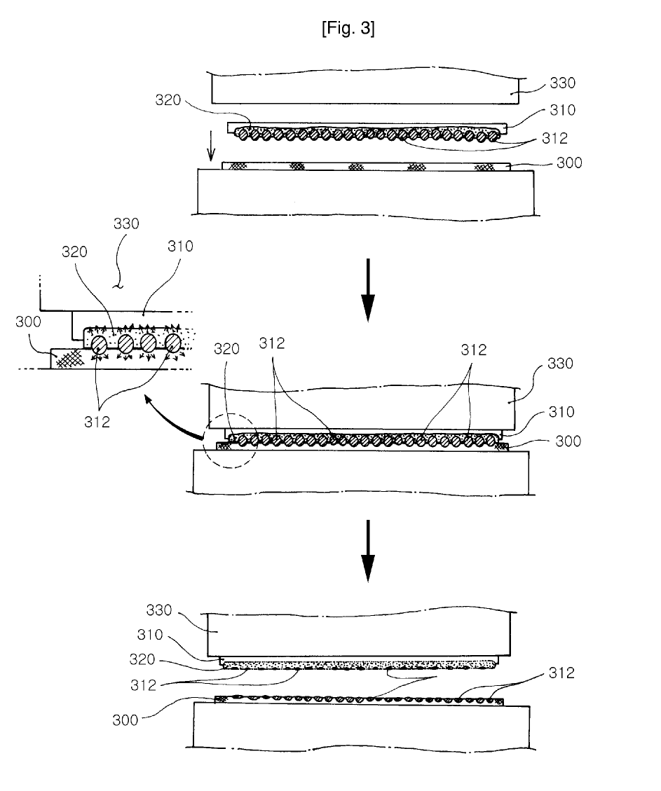

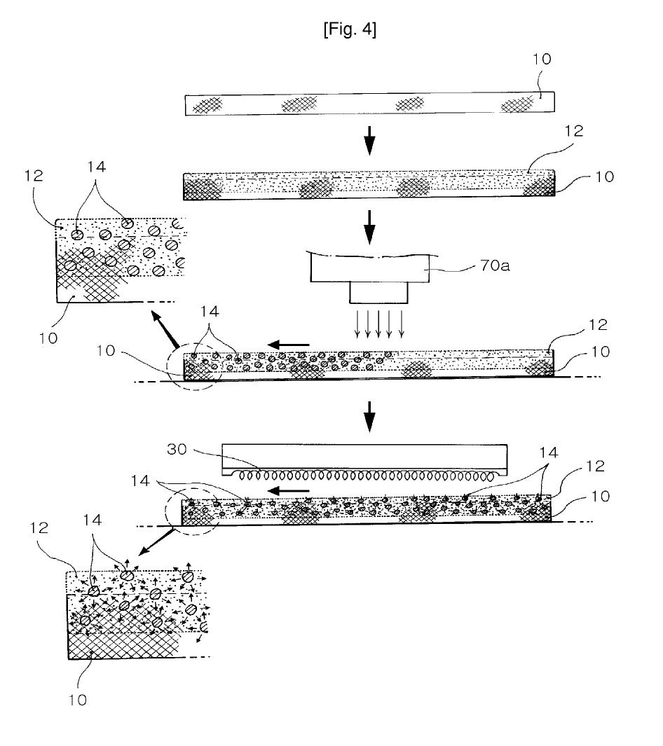

### BEST MODE FOR CARRYING OUT THE INVENTION

Hereinafter, preferred embodiments of the present invention will be described in detail with reference to the attached drawings.

The inventive non-contact type direct dye-sublimation printing method is designed to print patterns, an ornamental design or a picture on a printing object 10 using a heat transfer or sublimation transfer technology.

The inventive non-contact type direct dye-sublimation printing method is designed to print an image on the printing object 10 by directly carrying sublimation dye in the printing object 10 and heating the printing object 10 to sublimate the dye without using an intermediate transfer medium.

Therefore, since the intermediate transfer medium such as a transfer paper is not used, the printing costs can be saved. Furthermore, since no particular process for depressing the intermediate transfer medium onto the printing object 10 is required, a consecutive online printing for the printing object 10 becomes possible, thereby remarkably improving the productivity in the printing work.

The inventive non-contact type direct dye-sublimation printing method includes the process of forming an agent treatment layer 12 on the printing object 10.

The process of forming the agent treatment layer 12 is performed by infiltrating the treatment agent in the printing object such as the polyester fabric. That is, the process of forming the agent treatment layer 12 is performed by coating a mixture, which is formed by mixing a thickening agent such as a binder for preventing the dye from running, a color fixing improving agent such as acid for improving the color fixing property, an anti-oxidizing agent for maintaining the color fixing property, a carrier for enabling the transfer at a relatively low temperature and improving the color fixing property, and a solvent such as water at a predetermined rate, through a dipping process or a knife coating process.

The binder is one of alginic acid, polyvinyl alcohol, carboxyl methyl cellulose, and the like, that may be one of natural or synthetic water-soluble polymer. The color fixing improving agent may be one of acetic acid, formate and the like. The anti-oxidizing agent may be one of hydrogen peroxide, nitrobenzene sulfonate, and the like. Other chemical materials may be also used for each functional agent.

The carrier may be one of dichlorobenzene, trichlorobenzen, paraphenylphenol, and the like. These agents may be mixed with a non-ion surface-active agent and a solvent such as water to be used as emulsifier.

Since a process for forming the agent treatment layer 12 is well known in the art, the detailed description thereof will be omitted herein.

As described above, the agent treatment layer 12 having a uniform thickness is formed on the printing object 10.

Then, dye 14 is sprayed on the agent treatment layer 12 to carry a transfer image. In this process, an inkjet printer may be used to spray the dye 14.

That is, by depositing the liquid dye 14 on the agent treat layer 12, the transfer image is formed in the agent treatment layer 12. The liquid dye 14 is hardened to be a solid state at the normal temperature.

In this process, the liquid dye 14 is sprayed on and infiltrated in the agent treatment layer 12. As a result, the dye 14 is infiltrated in the printing object 10 and existed in the form of the solid state. In this case, the dye 14 can be definitely carried in the agent treatment layer 12 without being run and mixed.

After the above, the agent treatment layer 12 is heated to sublimate the dye 14 to perform the printing process. That is, by heating the agent treatment layer 12, the dye carried in the agent treatment layer 12 is sublimated and infiltrated into enlarged pores of the printing object 10, thereby printing the transfer image on the printing object.

In this process, the printing object 10 with the agent treatment layer 12 in which the dye 14 is carried is heated at a temperature of 160-250° C. by a heating unit such as a ceramic radiant heater or an electric resistance heater. As a result, pores of the texture of the printing object 10 are enlarged and the dye 14 carried in the agent treatment layer 12 is sublimated. The sublimated dye 14 is infiltrated in the pores of the texture of the printing object 10, thereby printing the transfer image on the texture of the printing object 10.

Accordingly, the process for clearly printing the image on the printing object can be very easily realized. That is, since the dye 14 is infiltrated into the enlarged pores of the printing object 10 in a state where the dye 14 is carried in the agent treatment layer 12 of the printing object 10 in advance, the dye 10 can be easily and deeply infiltrated into the texture of the printing object 10.

Furthermore, since the inventive non-contact type direct dye-sublimation printing method is not in need of an intermediate transfer medium such as an expensive transfer paper, the printing costs can be saved and the steps of work processes can be reduced. In addition, since there is no possibility that the dye 14 remains on the intermediate transfer medium, the unnecessary dye loss can be prevented. That is, the superior printing effect can be realized even with a small amount of the dye 14.

Moreover, since the dye 14 carried in the agent treatment layer 12 deposited on the printing object 10 is infiltrated into the printing object 10, the infiltration into the pores can be easily and uniformly realized as compared with the prior arts. As a result, the high definition printed image can be remained, thereby providing a high quality product.

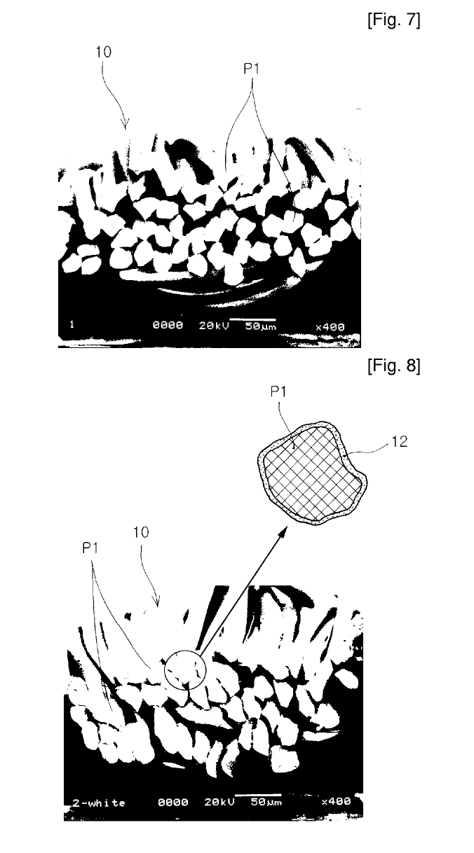

FIG. 7 is a photograph of a texture of a fabric that is being dyed by a non-contact type direct dye-sublimation printing method according to the present invention.

FIG. 7 is a photograph showing printing object 10 formed of polyester fabric to which the present invention is applied, the polyester fabric being formed of a plurality of yarns P1 defining the texture.

FIG. 8 is a photograph showing a section of the fabric that is agent-treated, in which the agent attached on the yarns P1 is shown in a white color in the photograph.

Next, when the dye 14 is sprayed, the dye 14 is carried in the agent treatment layer 12 enclosing the yarns P1.

At this point, in order to prevent the running of the dye 14, maintain the high definition image and improve the color fixing property, the agent treatment layer 12 may contain the thickening agent, the color fixing improving agent, and the antioxidant.

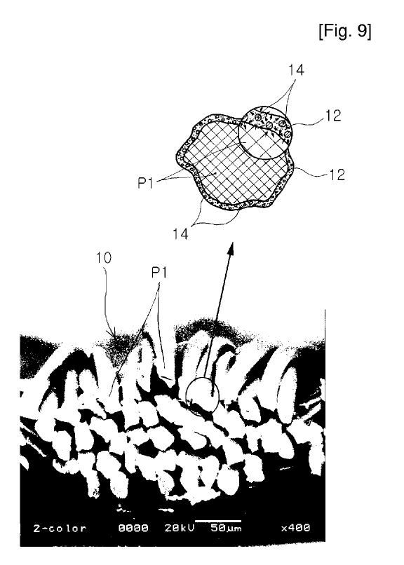

FIG. 9 is a photograph showing the fabric on which the image is printed by dye carried therein. Since the dye 14 attached on the agent treatment layer 12 and enclosing the yarns P1 is infiltrated into the yarns P1, the polyester fabric yarns P1 are thickly shown by being dyed in the photograph.

According to the inventive non-contact type direct dye-sublimation printing method, there is no need for the process for depressing the intermediate transfer medium on the printing object 10. That is, by adding a process for consecutively supplying the printing objects 10 on each of which the agent treatment layer 12 is formed and a process for consecutively collecting the printing objects on each of which an image is printed, a series of consecutive online printing processes can be realized.

The inventive non-contact type direct dye-sublimation printing method may, between the dye spraying process and the dye sublimation process, further include a speed separating process for separating a dye spraying speed from an image transfer speed to realize an optimal dye spray and an image transfer.

That is, before the printing object 10 is moved from the dye spraying unit 20 to the heating unit 30, a U-shaped drooping portion 10a is formed on the printing object 10 by the difference between the dye spray speed and the image transfer speed. At this point, by controlling the image transfer speed, the U-shaped drooping portion 10a may be eliminated. As a result, the dye can be sprayed at an optimal spray speed without depending on the image transfer speed.

By repeating this process, the operational speed of the dye spray unit 20 may be independent of the operational speed of the image transfer unit 80. That is, the dye spray unit 20 and the image transfer unit 80 can be operated at their optimal speeds to exhibit their typical performances.

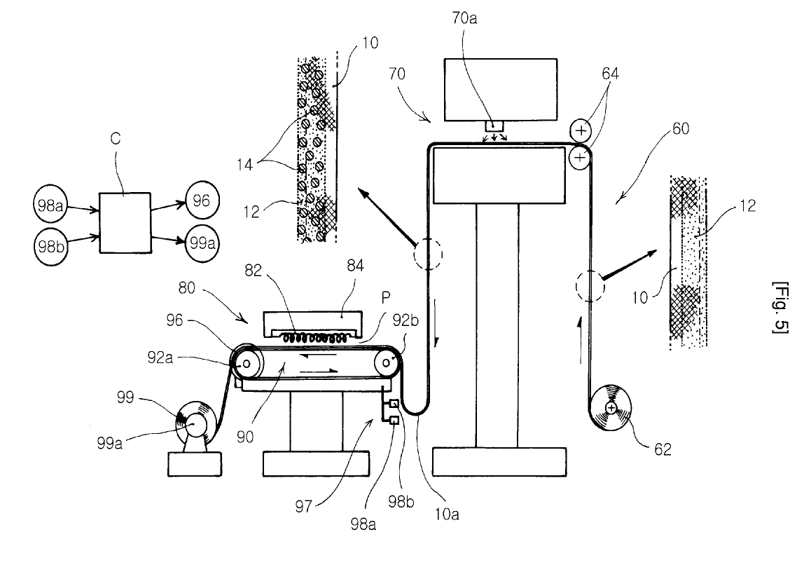

Meanwhile, the inventive non-contact type direct dye-sublimation printing apparatus 50 is designed in a simple and small constitution as shown in FIG. 5, to consecutively perform its printing operation for printing patterns, an ornamental design or a picture on the printing objects.

The inventive non-contact type direct dye-sublimation printing apparatus 50 may further include a supply unit 60 for supplying the printing objects 10 on each of which the agent treatment layer is formed.

The supply unit 60 includes a supply reel 62 around which the printing objects 10 are wound and a pair of pinch rolls 64 releasing the printing objects 64 from the supply reel 62. The pair of pinch rolls 64 may be provided in the inkjet printer 20 or may be provided independent of the inkjet printer 20. That is, a structure of the pair of pinch rolls 64 is not limited to these cases. That is, any structure that can release the printing objects 10 from the supply reel 62 and supply the released printing objects to an inkjet head 70a of a dye-depositing unit 70 that will be described later.

In addition, the inventive non-contact type direct dye-sublimation printing apparatus 50 includes the dye depositing unit 70 provided on a downstream side of the supply unit 60. The dye-depositing unit 70 is designed to spray the dye 14 on the agent treatment layer 12 to carry the dye 14 in the agent treatment layer 12.

The dye-depositing unit 70 may be formed of the conventional inkjet printer depositing the dye 14 on the transfer paper to carry the dye 14 in the transfer paper. That is, the inkjet printer has the inkjet head 70a injecting the dye 14 on the agent treatment layer 12 of the printing object in a desired design, pattern or paint.

The inventive non-contact type direct dye-sublimation printing apparatus 50 may further include the transfer unit 80 provided at a downstream side of the dye depositing unit 70. The transfer unit 80 heats the printing object 10 to sublimate the dye 14, thereby allowing the dye 14 carried in the agent treatment layer 12 to be infiltrated into enlarged pores of the texture of the printing object. The transfer unit 80 may include a tunnel type heating housing 84 and a heating unit 82 such as a ceramic radiant heater or an electric resistance heater and installed in the heating housing 84.

That is, the heating housing 84 defines a path P along which the printing object 10 moves. The heating unit 82 such as the ceramic radiant heater or the electric resistance heater is provide on the path P to heat the agent treatment layer 12 of the printing object at a temperature of 160-250° C.

In addition, a conveying unit 90 such as a belt conveyer is disposed in the heating housing 84 and spaced away from the heating unit 82 at a predetermined distance. The printing objects are disposed on and conveyed by the conveying unit 90. Alternatively, the conveying unit 90 may be formed of pinch rollers (not shown). The belt-conveying unit 90 includes an endless belt 94 wound on first and second pulleys 92a and 92b. The first pulley 92a is connected to a driving motor 96. When the driving motor 96 is driven, the belt 94 wound on the pulleys 92a and 92b rotates in the form of an endless track to convey the printing objects 10 disposed on the belt 94.

A printing object detecting unit 97 is disposed between the transfer unit 80 and the dye-depositing unit 70. The printing object detecting unit 97 includes upper and lower limit sensors 98a and 98b detecting the U-shaped drooping portion 10a.

That is, the lower and upper limit sensors 98a and 98b are disposed in a vertical direction and spaced away from each other by a predetermined gap. The U-shaped drooping portion 10a is detected by the lower and upper limit sensors 98a and 98b. The sensors 98a and 98b transmits the detected signal to a controller C to drive the driving motor 96 for the belt conveyer and a collection reel motor (not shown) that will be described later.

As shown in FIG. 5, when the supply speed of the printing objects 10 from the dye depositing unit 70 becomes faster than the output speed from the transfer unit 80, the U-shaped drooping portion 10a of the printing objects is formed between the dye depositing unit 70 and the transfer unit 80. When the drooping portion 10a is formed, the sensors 98a and 98b detect this. That is, when the lower limit sensor 98a detects the drooping portion 10, the driving speeds of the driving motor 96 for the conveying unit 90 and a rotational motor 99a of the collection reel are controlled to be faster than the printing object supply speed from the dye depositing unit 70 so that the printing objects 10 can be moved through the transfer unit 80.

In this case, the moving speed of the printing object 10 moving through the transfer unit 80 is faster than the moving speed through the depositing unit 70. Therefore, the drooping of the U-shaped drooping portion 10a is gradually reduced. Therefore, the drooping portion 10a is not detected by the lower limit sensor 98b but by the upper limit sensor 98b.

When the drooping portion 10a is further reduced not to be detected by the upper sensor 98b, the sensor 98b transmits the signal to the controller C so that the driving speeds of the driving motor 96 for the conveying unit and the rotational motor 99a for the collection reel 99 can be reduced. In this case, the printing object moving speed determined by the driving motor 96 for the conveying unit and the rotational motor 99a for the collection reel 99 is set to be lower than the moving speed of the printing object supplied from the dye-depositing unit 70.

Therefore, the U-shaped drooping portion 10a is formed again between the dye depositing unit 70 and the transfer unit 80. By the above-described process, the operational speed of the dye-depositing unit 70 is independent of that of the transfer unit 80. That is, the dye depositing unit 70 and the transfer unit 80 can be operated at their typical optimal speeds.

In the present invention, the heating housing 84 of the heating unit 80 is designed such that it takes about 20-180 seconds for the printing object to pass therethrough. Therefore, while the printing object passes through the heating housing 84, the dye 14 can be completely sublimated to be fully infiltrated into the printing object.

Furthermore, when the transfer unit 80 is detachably provided in front of the dye-depositing unit 70, the apparatus can be made to be more compact.

The dyed printing objects 10 are collected in the form of a roll by the collection reel 99 disposed on the downstream side of the transfer unit 80. At this point, the rotational speeds of the supply reel 62 and the collection reel 99 may be properly adjusted considering the dye and transfer speeds of the printing objects,

As described above, the inventive non-contact type direct dye-sublimation printing apparatus can be manufactured in a simple structure and a small size by omitting a pressing plate, a thermostat and other relating parts that are required in a process for depressing an intermediate transfer medium, thereby reducing the facility costs and the initial investing costs and to provide a printing method using such a printing apparatus.

Particularly, since the dye is sublimated as the printing object passes through the tunnel type transfer unit 80 that is detachably provided in front of the dye-depositing unit 70 such as, for example, the inkjet printer, the overall size of the apparatus can be reduced.

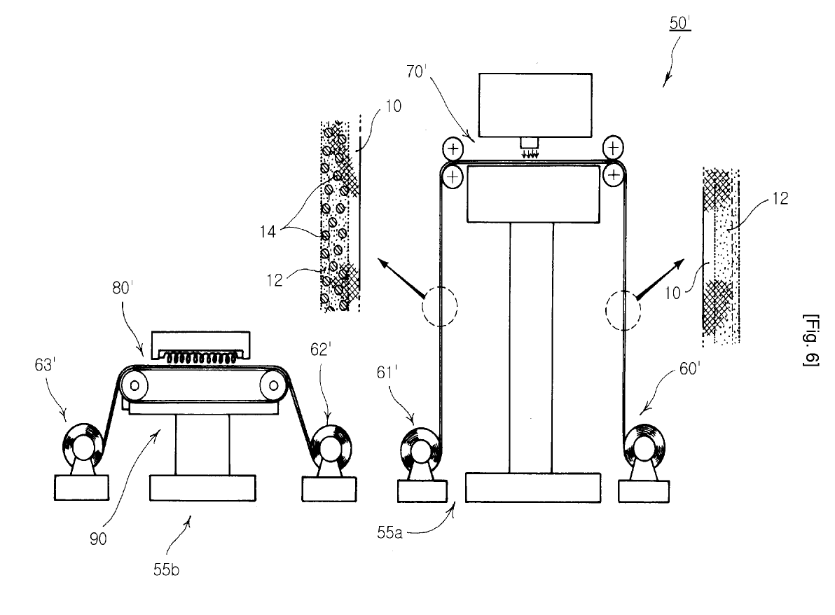

According to another embodiment of the present invention that is depicted in FIG. 6, the dye depositing unit and the transfer unit may be independently provided in the apparatus.

That is, the apparatus of this embodiment includes a first supply unit 60′, a dye depositing unit 70′ disposed at a downstream side of the first supply unit 60′ to carry the transfer image in the agent treatment layer 12, and a pretreatment unit 55a having a first collection unit 61′ collecting the printing object 10 carrying the dye.

The first supply unit 60′ is identical to the supplying unit 60 depicted in FIG. 5 in functional and constitutional aspects. The dye depositing unit 70′ is identical to the dye depositing unit 70 depicted in FIG. 5 in functional and constitutional aspects. The first collection unit 61′ is functionally identical to the collection reel 99 and the motor 99a that are depicted in FIG. 5.

In addition, the apparatus of this embodiment may further include a second supply unit 62′ supplying the printing object 10 carrying the dye from the pretreatment unit 55a, a transfer unit 80′ disposed at a downstream side of the second supply unit 62′ to sublimate the dye carried in the agent treatment layer by heating the printing object 10, to allow the sublimated dye to be infiltrated into the enlarged pores of the texture of the printing object 10, and a post-treatment unit 55b having a second collection unit 63′ collecting the dyed printing object.

In the post-treatment unit 55b, the second supply unit 62′ supplying the printing object carrying the dye in the form of the supply reel is provided instead of the printing object detecting unit 97 located on the upstream side of the transfer unit 80 that is described with reference to FIG. 5. Thus, the upper and lower sensors 98a and 98b detecting the drooping portion of the printing object 10 are not required in this embodiment.

A feature of this embodiment as described in FIG. 6, is that the dye depositing unit 70′ and the transfer unit 80′ are provided as independent units. However, since the structure and function of the dye depositing unit 70′ and the transfer unit 80′ are identical to those described in the forgoing embodiments, the detailed description thereof will be omitted herein.

By the above-described modified structure, the dye-carrying printing objects produced from the pretreatment unit 55a can be further processed through the post-treatment unit 55b as an online process.

Although the preferred embodiments of the present invention have been disclosed for illustrative purpose, those skilled in the art will appreciate that various modifications, additions and substitutions can be made without departing from the scope and spirit of the invention as defined in the accompanying claims.

### INDUSTRIAL APPLICABILITY

According to the present invention, the non-contact type direct dye-sublimation printing apparatus can be manufactured in a simple structure and a small size by omitting a pressing plate, a thermostat and other relating parts that are required in a process for depressing an intermediate transfer medium, thereby reducing the facility costs and the initial investing costs and to provide a printing method using such a printing apparatus.

1. A non-contact type direct dye-sublimation printing method comprising the steps of:
forming an agent treatment layer in a printing object;
carrying solid sublimation dye in the agent treatment layer by spraying liquid sublimation dye on the agent treatment layer to allow a transfer image to be infiltrated into the agent treatment layer and hardening the liquid sublimation dye infiltrated into the agent treatment layer; and
printing the transfer image on the printing object by sublimating the dye carried on the agent treatment layer and infiltrating the sublimated dye into enlarged pores of a texture of the printing object by heating the printing object.

2. The non-contact type direct dye-sublimation printing method of claim 1, further comprising, between the step of carrying the solid sublimation dye and the step of printing the transfer image, the step of separating a dye spraying speed from an image transfer speed.

3. The non-contact type direct dye-sublimation printing method of claim 2, wherein in the step of separating the dye spraying speed from the image transfer speed, a drooping portion is formed on the printing object by a speed difference between the dye spraying speed and the image transfer speed before the printing object is conveyed to a dye spraying unit and the drooping portion is eliminated by controlling the image transfer speed, thereby providing an optimal dye spraying speed by making the dye spraying speed independent of the image transfer speed.

4. The non-contact type direct dye-sublimation printing method of claim 1, wherein the agent treatment layer is heated by a heating unit.

5. The non-contact type direct dye-sublimation printing method of claim 1, wherein the heating unit is selected from the group consisting of a ceramic radiant heater, an electric resistance heater and a lamp heater.

6. A non-contact type direct dye-sublimation printing apparatus comprising:
a printing object supply unit having a supply reel around which a printing object with an agent treatment layer is rolled and a pair of pinch rolls releasing the printing object from the supply reel;
a dye depositing unit disposed at a downstream side of the supply unit to allow dye to be carried in the agent treatment layer; and
a transfer unit disposed at a downstream side of the dye depositing unit to print a transfer image on the printing object by sublimating the dye carried in the agent treatment layer and infiltrating the sublimated dye into enlarged pores of a texture of the printing object by heating the printing object.

7. The non-contact type direct dye-sublimation printing apparatus of claim 6, wherein the transfer unit includes a tunnel type heating housing and a heating unit disposed in the heating housing.

8. The non-contact type direct dye-sublimation printing apparatus of claim 7, wherein the heating unit is selected from the group consisting of a ceramic radiant heater, an electric resistance heater and a lamp heater.

9. The non-contact type direct dye-sublimation printing apparatus of claim 7, further comprising a conveying unit disposed at a predetermined distance from the heating unit to move the printing object at a predetermined speed.

10. The non-contact type direct dye-sublimation printing apparatus of claim 9, wherein the conveying unit is one of a belt conveyer and a pinch roller.

11. The non-contact type direct dye-sublimation printing apparatus of claim 6, further comprising a printing object-detecting unit disposed between the dye depositing unit and the transfer unit.

12. The non-contact type direct dye-sublimation printing apparatus of claim 11, wherein the printing object detecting unit comprises upper and lower sensors disposed in a vertical direction to detect a drooping portion of the printing object.

13. The non-contact type direct dye-sublimation printing apparatus of claim 6, wherein the transfer unit is closely disposed in front of the dye depositing unit to make the apparatus more compact.
